(19) United States
(12) Patent Application Publication
(10) Pub. No.: US 2003/0106974 A1
(43) Pub. Date: Jun. 12, 2003

(54) Apparatus and method for mounting accessories to a motorcycle

(76) Inventor: Jeffery W. Guertin, St. Paul, MN (US)

Correspondence Address: BRIGGS AND MORGAN, P.A., 2400 IDS CENTER, MINNEAPOLIS, MN, 55402, US

(21) Appl. No.: 10/010,844

(22) Filed: Dec. 6, 2001

(51) Int. Cl. A47K 1/00; F16L 3/08; E04G 5/06

(52) U.S. Cl. 248/309.1; 248/227.4; 248/230.5

(57) ABSTRACT

An apparatus and methods for securing an accessory to a vehicle are provided. The apparatus is suitable for securing a wide variety of accessories to vehicles. The apparatus includes a coupling, a bracket and a clip. The clip can be secured to an accessory. The bracket extends from the coupling and is configured to receive the clip so that the clip is secured to the bracket. The bracket can also include a recess to receive a portion of the clip to secure the clip to the bracket.

### BACKGROUND OF THE INVENTION

1. Field of the Invention

The present invention relates to an apparatus and methods for mounting accessories on a vehicle and, more particularly, to an apparatus and methods mounting accessories to the handlebars of a vehicle.

2. Description of the Related Art

Motorcycling and bicycling are popular pastimes and are the primary means for transportation of millions of people around the world. Riders of motorcycles and bicycles frequently have a need to mount a variety of accessories to their vehicles to meet safety requirements, for entertainment purposes, to warn them of potential danger or law enforcement, or simply for the adornment of their vehicles. The devices for mounting of the accessories on either bicycles or motorcycles can be cumbersome. In addition, the space for mounting devices for such purposes however is limited. Therefore, a need exists for an apparatus and methods that permit a compact means for mounting a variety of accessories on a bicycle or motorcycle. Furthermore, a need exists for a mount that may be mounted in a variety of positions on a bicycle so as to allow proper positioning relative to the various instruments and controls commonly found on bicycles and motorcycles.

Further, the riders of bicycles and motorcycles frequently have a variety of accessories available for mounting on their motorcycle or bicycle that are tailored for certain circumstances. When cruising, a rider may desire to have a radio mounted to his bike to allow the user to listen to music while riding. When riding with friends, a rider may desire to have a radar detector mounted to his bike to alert the rider to radar traps. On the fourth of July, a rider may desire to mount an American flag to his bike. In yet other situations, a rider may desire to mount other accessories on his bike. Devices designed to secure accessories to handlebars have generally been designed for specific applications. Clamping devices have been particularly configured to secure lights, radios, mirrors, radar detectors and other accessories to the handlebars of bicycles and motorcycles. Thus, the changing between different accessories has been cumbersome, requiring the removal of the device for securing the original accessory to the handle bar and securing a separate device for securing the replacement accessory on the handlebar. Therefore a need exists for an apparatus and methods for mounting accessories to handlebars that is flexibly configured to receive a variety of accessories.

While riding bicycles and motorcycles, motorcycle or bicycle, the rider, and the accessories on the bicycle are subject to a variety of physical forces. Rough pavement, potholes and even the force of the wind against accessories can cause the accessories to become dislodged from their mounts. The loss of or damage to accessories that can be caused by their dislodging from the mount can be costly and frustrating to a rider. Therefore, a need exists for a mounting apparatus that securely mounts an accessory and can withstand the substantial forces which the accessories are typically exposed to during a ride.

Further, due to the proximity to the rider, accessories are often mounted on the handlebars of either bicycles or motorcycles. This allows the driver to monitor and/or access the device easily while riding. However, the handling of the vehicle can be adversely effected by securing a mounting device to the handlebars and the adverse effects are amplified with the more cumbersome mounting devices. The adverse effects to handling reduce the performance envelope in which the bicycle or motorcycle can safely operate. Therefore, a need exists for an apparatus and method that does not inhibit the performance of the bicycle or motorcycle.

Bicycles and motorcycles are often designed to reduce their overall weight to enhance their performance and portability. Thus, the unnecessary addition of weight is generally considered undesirable. Not only are many mounting devices cumbersome, many mounting devices are quite heavy. Given the lightweight design of many motorcycles and bicycles, this additional weight is frequently considered undesirable. Therefore, a need exists for an apparatus and methods for mounting accessories that is lightweight so as not to significantly increase the weight of the vehicle to which the apparatus is attached.

### SUMMARY OF THE INVENTION

The present invention satisfies the above need and provides additional improvements and advantages that will be recognized by those skilled in the art upon review of the present disclosure.

An apparatus in accordance with the present invention includes a coupling, a bracket, and a clip. The coupling is adapted to be secured to a bar of a vehicle. The coupling can include an aperture configured to secure the coupling to a bar comprising at least a portion of a bar, such as a handlebar. The bracket extends from the coupling and includes a mounting portion. The clip includes at least one arm and a body, the at least one arm secured over the mounting portion of the bracket. The mounting portion of the bracket can include a pair of guides configured to guide at least a portion of the clip along the mounting portion of the bracket. The mounting portion of the bracket may also include a recess configured to receive at least a portion of the arm of the clip. The clip can further include a detent on the arm of the clip. The detent of the clip cooperating with the recess of the mounting portion, when present, to further secure the clip to the mounting portion of the bracket.

The recess can be an attachment aperture configured to receive the detent of the arm and to thereby secure the clip to the mounting portion of the bracket.

An accessory can be secured to the body of the clip to allow the accessory to be secured to the mounting portion of the bracket. The accessory can be a bag, a video camera, a radar detector, a radio, a flag, a beverage holder or other accessory.

It is thus an object of the present invention to provide novel apparatus and methods for securing an accessory to a bar on a vehicle.

It is further an object of the present invention to provide such novel apparatus and methods which can secure an remove an accessory in a simple operation.

It is further an object of the present invention to provide such novel apparatus and methods to secure an accessory in an orientation adjacent a bar of a vehicle.

It is further an object of the present invention to provide such novel apparatus and methods which can secure an accessory to a vehicle and retain the accessory on the vehicle while the vehicle is moving.

It is further an object of the present invention to provide such novel apparatus and methods which can be lightweight.

It is further an object of the present invention to provide such novel apparatus which can be compact.

It is further an object of the present invention to provide such novel apparatus and methods which can be secured in limited spaces on a bar.

It is further an object of the present invention to provide such novel apparatus which can be inexpensive to manufacture.

It is further an object of the present invention to provide such novel apparatus and methods utilizing a minimum of moving parts.

These and other objects, features, and advantages of the present invention will become more readily apparent from the following detailed description of the preferred embodiment of the invention when taken in conjunction with the drawings wherein like reference numerals refer to corresponding parts in the several views.

### BRIEF DESCRIPTION OF THE DRAWINGS

The illustrative embodiment may best be described by reference to the accompanying drawings where:

FIG. 1 illustrates a perspective view of an embodiment of an apparatus for mounting an accessory in accordance with the present invention;

FIG. 2 illustrates a side view in cross-section of an embodiment of an apparatus as in FIG. 1 according to section line 2-2 of FIG. 1;

FIG. 3 illustrates a perspective view of an embodiment of an apparatus for mounting an accessory in accordance with the present invention mounted on the handlebars of a motorcycle;

FIG. 4 illustrates a perspective view of a device in accordance having a clip configured to secure a video camera;

FIG. 5 illustrates a perspective view of a device in accordance having a clip configured to secure a radar detector;

FIG. 6 illustrates a perspective view of a device in accordance having a clip configured to secure a radio;

FIG. 7 illustrates a perspective view of a device in accordance having a clip configured to secure a flag;

FIG. 8 illustrates a perspective view of a device in accordance having a clip configured to secure a cellular telephone; and

FIG. 9 illustrates a perspective view of a device in accordance having a clip configured to secure a beverage holder.

All figures are drawn for ease of explanation of the basic teachings of the present invention only; the extensions of the figures with respect to number, position, relationship and dimensions of the parts to form the preferred embodiment will be explained or will be within the skill of the art after the following description has been read and understood. Further, the exact dimensions and dimensional proportions to conform to specific force, weight, strength, and similar requirements will likewise be within the skill of the art after the following description has been read and understood.

Where used in various figures of the drawings, the same numerals designate the same or similar parts. Furthermore, when the terms “top,” “bottom,” “right,” “left,” “forward,” “rear,” “first,” “second,” “inside,” “outside,” and similar terms are used, the terms should be understood to reference only the structure shown in the drawings as it would appear to a person viewing the drawings and utilized only to facilitate describing the illustrated embodiment.

### DETAILED DESCRIPTION OF THE PREFERRED EMBODIMENT

An apparatus for mounting an accessory to a handlebar or other bar of a vehicle while utilizing methods according to the teachings of the present invention is shown in the drawings and generally designated 10. Mounting apparatus 10 is generally configured to allow the removable attachment of an accessory 40 to a bar 18 of a vehicle. The vehicle may be a motorcycle, a bicycle, an all terrain vehicle, a personal watercraft, a snowmobile, and other vehicles having handlebars or another bar that is accessible for mounting the accessory. Mounting apparatus 10 as illustrated generally throughout the Figures is configured to mount accessory 80 on a handlebar 18 of a vehicle 30 for exemplary purposes only.

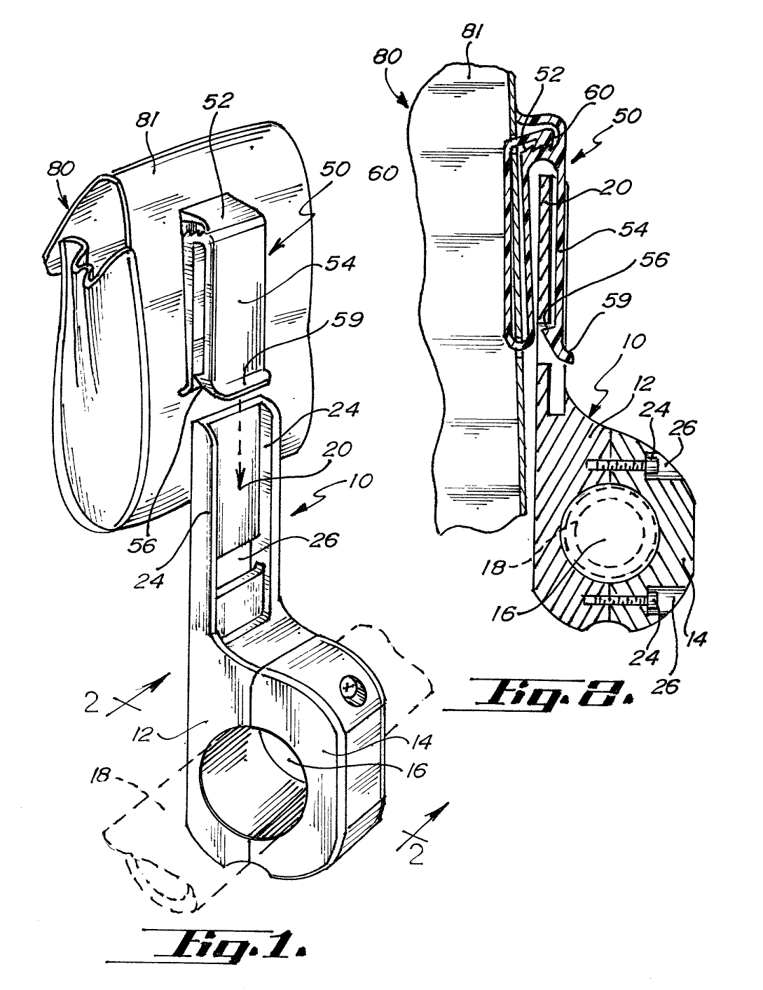

Mounting apparatus 10 includes a coupling 12, a mounting portion 20, and a clip. As illustrated in FIG. 1, coupling 12 may include a clamp portion 14. Coupling 12 is illustrated having the clamp portion 14 to secure coupling 12 to a handlebar for exemplary purposes. Coupling 12 may be configured in a variety of configurations to permit coupling 12 to be secured to a bar as will be recognized by those skilled in the art upon review of the present disclosure. Coupling 12 can constructed from a metal or rigid plastic having sufficient strength and durability to secure an accessory 40 to a vehicle 30. Coupling 12 is attached to clamp portion 14 or coupling 12 may be integral with clamp portion 14 so as to permit coupling 12 to be secured to a bar.

Generally, clamp portion 14 is configured to secure coupling 12 to a bar of a vehicle. In the embodiment shown, coupling 12 and clamp portion 14 cooperate to define an aperture 16 generally shaped to receive a bar 18 (shown in phantom). Clamp portion 14 may be alternatively shaped or have an interchangeable insert to allow the aperture 16 to receive a variety of different sizes and shapes of bars 18. Clamp portion 14 may be attached to coupling 12 by a pair of screws 24. Screws 24 are shown passing through attachment apertures 26 on clamp portion 14 and threadably received in coupling 12 for exemplary purposes only. Screws 14 allow the permanent mounting of mounting apparatus 10 to bar 18 and provide a clean finished appearance to mounting apparatus 10. Alternatively, screws 14 may be provided with wing nuts to permit a user to move or remove mounting apparatus 10 without additional tools. In yet another alternative, clamp portion 14 may be hingably mounted to coupling 12 and secured in a closed position by a latch attached to either or both of clamp portion 14 and/or coupling 12. This configuration also allows mounting apparatus 10 to be moved or removed without additional tools. Additional configurations for clamp portion 14 suitable for attaching coupling 12 to bar 18 will be recognized by those skilled in the art upon review of the present disclosure.

Coupling 12 further includes a mounting portion 20 to receive a clip 50. Generally, mounting portion 20 extends from coupling 12. Mounting portion 20 may be integral with the body or may be secured to the body. Mounting portion 20 is generally shaped to cooperate with a clip 50 to allow clip 50 to be secured to mounting portion 20. An accessory 80 is typically attached to clip 50. Therefore, mounting portion 20 is typically designed and constructed to have sufficient strength to withstand the physical stresses of supporting the combined weight of clip 50 and accessory 80.

In the embodiment shown, mounting portion 20 is an elongated flattened portion of coupling 12 that is illustrated as integral with coupling 12 for exemplary purposes only. Mounting portion 20 may also include a pair of guides 24 and may includes a recess 26. Guides 24 can function to guide the arms of a clip into a secured position over mounting portion 20 and can maintain clip 50 on mounting portion 20 once clip 50 is positioned on mounting portion 20. Recess 26 can receive a portion of clip 50 to further secure clip 50 over mounting portion 20 of mounting apparatus 10 and can allow a user to recognize the proper positioning of clip 50 on mounting portion 20 by providing a “click” sound when clip 50 engages recess 26. FIG. 1 illustrates recess 26 as an aperture for exemplary purposes only.

Clip 50 generally includes a clip body 52 and at least one clip arm 54. Clip body 52 is configured to be attached to or is integral with an accessory 80. Clip arm 54 extends from clip body 52 and is configured to allow clip 50 to be secured about mounting portion 20. In one embodiment, clip arm 54 may be compressionally biased against clip body 52 to secure mounting portion 20 between clip body 52 and clip arm 54. In yet another embodiment, a first clip arm 54 may further include a clip detent 56 to be received in recess 26 of mounting portion 20 to secure clip 50 to mounting portion 20. Detent 56 may be further provided with one or more flanges 58 to further secure or lock clip arm 54 within recess 26. A finger hold 59 may also be provided on the end of clip arm 54 to aid in disengaging detent 56 from recess 26 and to aid in sliding the clip from mounting portion 20 of coupling 12.

Clip 50 may further include a clasp 60, shown in FIG. 2, to secure clip 50 to accessory 80. As illustrated in FIG. 2, clasp 60 is secured to an accessory 80, shown as a bag 81 for exemplary purposes. The clasp includes a clasp arm 62 having a clasp detent 64 at an end of clasp arm 62. Clasp detent 64 further includes one of more flanges configured to engage clip body 52 to prevent the release of the accessory 80 from clip 50. As illustrated for exemplary purposes, clasp 60 of clip 50 is inserted through a first slot in bag 81 and clasp detent 64 is passed through a second slot in bag 81 to engage clip body 52 of clip 50 and, thus, secures bag 81 to clip 50. Clip 50 can also be integral with accessory 80, can be attached by screws, nuts and bolts or by similar fasteners, or can be otherwise configured to interlock with accessory 80.

The particular manner in which mounting portion 20 and clip 50 cooperate varies. As illustrated in FIGS. 1 to 8 for exemplary purposes, clip 50 has at least one clip arm 54 placed over mounting portion 20 of coupling 12. Clip 50 and accessory 80 are then slid downward (as shown in the figures) along mounting portion 20. Guides 24 disposed on both sides of clip arm 54 guide clip 50 along the length of mounting portion 20 and maintain the position of clip 50 so that detent 56 of clip arm 54 is received within recess 26 of mounting portion 20. Once detent 56 is positioned within recess 26, accessory 80 is firm secured to mounting apparatus 10. As stated above, the particular manner in which mounting portion 20 and clip 50 cooperate varies. The clip may not include a detent, but may be compressionally secured over the mounting portion 20 so as to secure clip 50 to apparatus 10. The end of clip arm 54 may not include a detent 56 but may be otherwise configured to be received within recess 26 to secure clip 50 to mounting portion 20. Other embodiments for securing clip 50 to mounting portion 20 will be evident to those skilled in the art upon review of this disclosure.

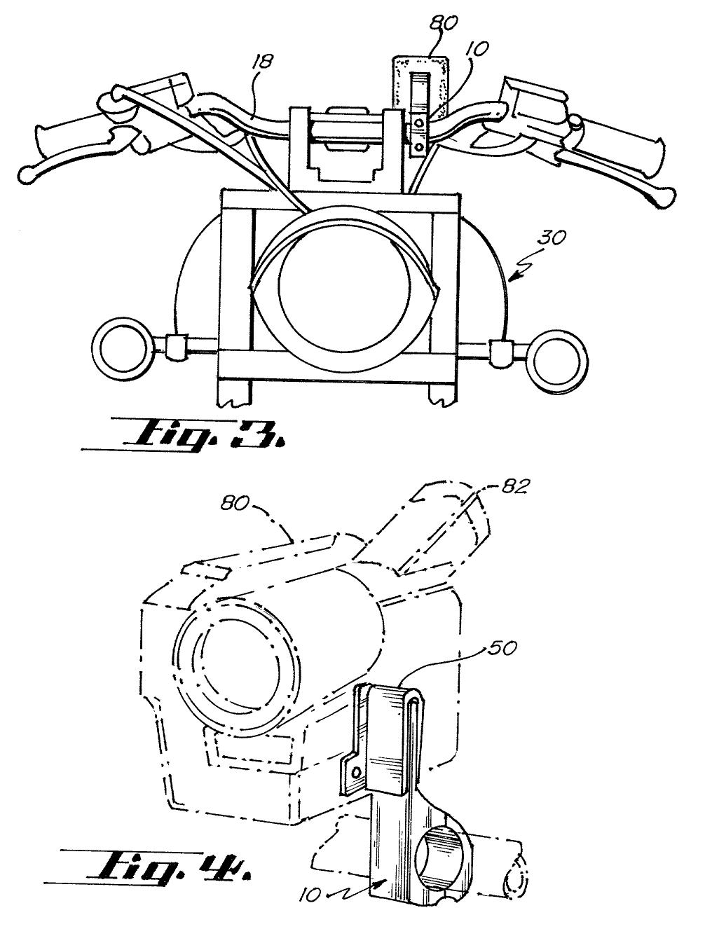

FIG. 3 illustrates an exemplary attachment of a mounting apparatus 10 securing an accessory 80 to a handlebar 18 of a motorcycle 30. The positioning of mounting apparatus 10 on handlebar 10 enables a user to view and access accessory 80 while riding. The mounting portion 20 is shown extending vertically for exemplary purposes. Alternatively, mounting apparatus 10 can be mounted to a sissy bar, a frame tube or other portion of vehicle 30 as will be recognized by those skilled in the art upon review of the present disclosure.

A wide variety of accessories 80 may be mounted on mounting apparatus 10. FIG. 4 illustrates an exemplary mounting of a video camera 82 as accessory 80. Video camera 82 is shown mounted to record along a parallel to the longitudinal axis of clip 50 and parallel to mounting portion 20 of coupling 12. Clip 50 and mounting portion 20 can also be configured to position video camera 82 to record along a perpendicular their longitudinal axis or may otherwise configured to allow a rider to record from a desired angle.

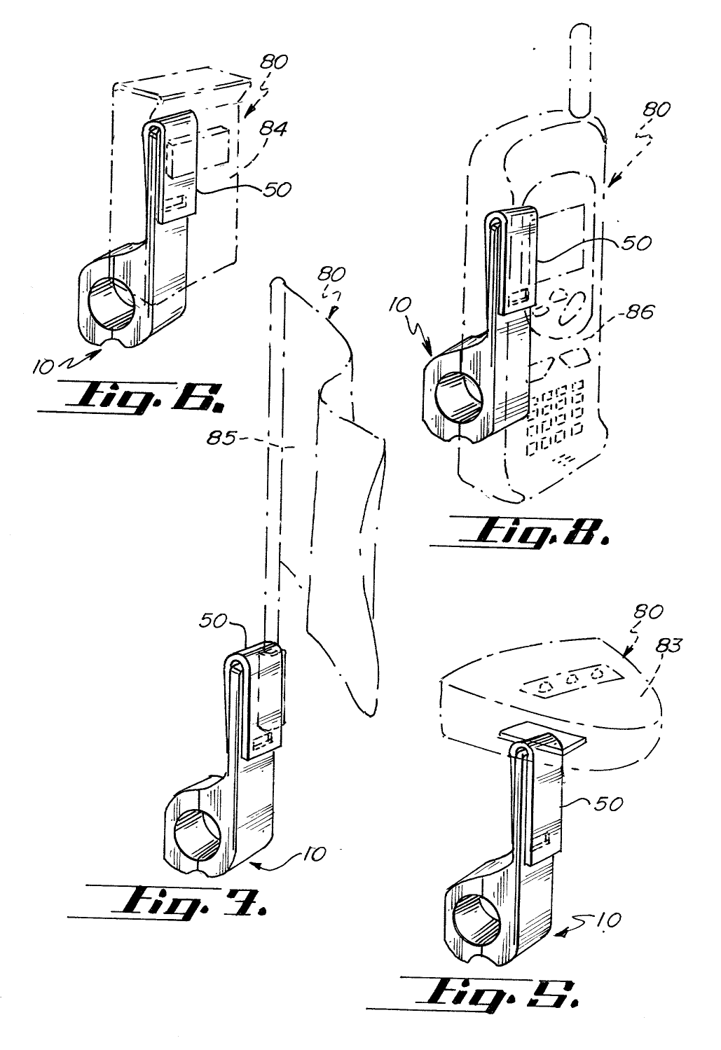

FIG. 5 illustrates an exemplary mounting of a radar detector 83 as accessory 80. Radar detector 83 is shown mounted along a perpendicular to the longitudinal axis of clip 50 and mounting portion 20 to position the radar/laser sensors of radar detector 83 at the highest point for best reception of signals. Clip 50 and mounting portion 20 can also be configured to position radar detector 83 parallel to their longitudinal axis or may otherwise configured to more discretely monitor police radar and laser.

FIG. 6 illustrates an exemplary mounting of a radio 84 as accessory 80. Radio 83 is shown for exemplary purposes mounted along a parallel to the longitudinal axis of clip 50 and mounting portion 20 to position the best position the antennae to receive radio signals and to best allow a rider to access the controls of radio 84. Clip 50 and mounting portion 20 can also be configured to position radio 84 perpendicular to their longitudinal axis or may otherwise configured for ease of use and the listening enjoyment of the rider.

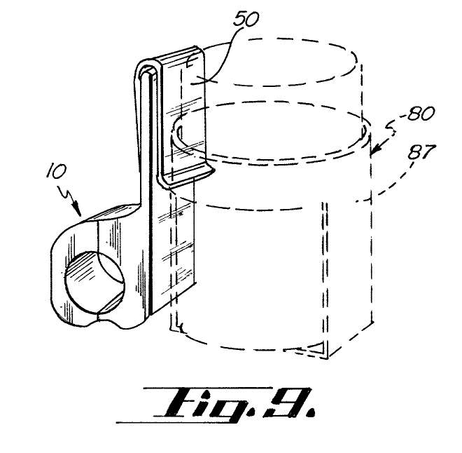

FIG. 7 illustrates an exemplary mounting of a flag 85 as accessory 80. The positioning of mounting apparatus 10 on handlebar 10 enables a user to view flag 85 while riding. Alternatively, mounting apparatus 10 and flag 85 can be mounted to a sissy bar, a frame tube or other portion of vehicle 30 as desired by the rider.

FIG. 8 illustrates an exemplary mounting of a cellular telephone 86 as accessory 80. Cellular telephone 86 is shown for exemplary purposes mounted along a parallel to the longitudinal axis of clip 50 and mounting portion 20 to best position the antennae for reception of cellular transmissions and to best allow a rider to monitor and access cellular telephone 86. Clip 50 and mounting portion 20 can also be configured to position cellular telephone 86 perpendicular to their longitudinal axis or may otherwise configured as desired by the rider.

FIG. 9 illustrates an exemplary mounting of a drink holder 87 as accessory 80. Drink holder 87 is shown for exemplary purposes mounted along a parallel to the longitudinal axis of clip 50 and mounting portion 20 for exemplary purposes. Drink holder 87 is generally mounted to clip 50 and mounting portion 20 to allow the rider to best access his beverage while most effectively preventing the beverage from spilling.

In use, a mounting apparatus 10 having a coupling 12, a mounting portion 20, and a clip 50 is provided. As illustrated, screws 24 passing through attachment apertures 26 are loosened to permit a bar 18 to be positioned in aperture 16. Mounting portion 20 is oriented so that an accessory 80 secured to mounting portion 20 by clip 50 is properly oriented for utilization by the rider. Screws 24 are then tightened to secure mounting apparatus 10 to bar 18. Clip 50 including an accessory 80 is then positioned and secured over mounting portion 20. Alternatively, clip 50 may be secured to mounting portion 20 and then apparatus 80 may be secured to clip 50 to secure apparatus 80 to mounting portion 20.

Since the disclosed invention may be embodied in other specific forms without departing from the spirit or general characteristics of the invention, the embodiments described in this disclosure are to be considered in all respects illustrative and not restrictive. The scope of the invention is to be indicated by the appended claims, rather than by the foregoing description, and all changes which come within the meaning and range of equivalency of the claims are intended to be embraced by the following claims.

What is claimed:

1. An apparatus for mounting an accessory to a vehicle, comprising:
a coupling adapted to be secured the to a bar;
a bracket extending from the coupling, the bracket including a mounting portion; and
a clip including at least one arm and a body, the at least one arm secured over the mounting portion of the bracket.

2. An apparatus, as in claim 1, with the mounting portion of the bracket further comprising a recess configured to receive at least a portion of the arm of the clip.

3. An apparatus, as in claim 2, with the clip further comprises a detent on the arm of the clip, the detent of the clip cooperating with the recess of the mounting portion to further secure the clip to the mounting portion of the bracket.

4. An apparatus, as in claim 3, wherein the recess comprises an attachment aperture configured to receive the detent of the arm to secure the clip to the mounting portion of the bracket.

5. An apparatus, as in claim 1, with the mounting portion of the bracket further comprising a pair of guides configured to guide at least a portion of the clip along the mounting portion of the bracket.

6. An apparatus, as in claim 1, with the coupling having an aperture configured to secure the coupling to a bar comprising at least a portion of a handlebar.

7. An apparatus, as in claim 1, further comprising an accessory secured to the body of the clip.

8. An apparatus, as in claim 7, with the accessory comprising a bag.

9. An apparatus, as in claim 7, with the accessory comprising a video camera.

10. An apparatus, as in claim 7, with the accessory comprising a radar detector.

11. An apparatus, as in claim 7, with the accessory comprising a radio.

12. An apparatus, as in claim 7, with the accessory comprising a flag.

13. An apparatus, as in claim 7, with the accessory comprising a beverage holder.

14. An apparatus for mounting an accessory to a vehicle, comprising:
a means for securing the accessory attached to the accessory;
a means for mounting configured to be removably secured to the means for securing the accessory; and
a means for securing the means for mounting to a bar on the vehicle.

15. A method for mounting an accessory to a vehicle, comprising:
providing a mounting apparatus including a coupling adapted to secure the coupling to a bar, a bracket extending from the coupling, the bracket including a mounting portion, and a clip including at least one arm and a clip body attached to the accessory; and
securing the at least one arm of the clip over the mounting portion of the bracket to attach the accessory to the mounting portion.
